(19) United States
(12) Patent Application Publication
(10) Pub. No.: US 2009/0049403 A1
(43) Pub. Date: Feb. 19, 2009

(54) METHOD AND SYSTEM FOR CREATING AN AFFILIATE ITEM SHOWCASE

(75) Inventor: Jessie Jones, Seattle, WA (US)

Correspondence Address: THE HECKER LAW GROUP, 1925 CENTURY PARK EAST, SUITE 2300, LOS ANGELES, CA, 90067, US

(73) Assignee: PRESTO GIFTO, INC.

(21) Appl. No.: 12/044,856

(22) Filed: Mar. 7, 2008

Related U.S. Application Data
(60) Provisional application No. 60/906,176, filed on Mar. 9, 2007.

(51) Int. Cl. G06F 3/048

(52) U.S. Cl. 715/810

(57) ABSTRACT

A method and a system for building a customizable affiliate website showcase are disclosed. In one or more embodiments, the system and method for building the showcase comprises receiving item data feeds from multiple sellers belonging to multiple affiliate networks, parsing the data feeds and generating a comprehensive list of items is from the data feeds. The list is categorized into several schemes of categorization. An affiliate selects desired items from the comprehensive list, and webpage code for a customizable item showcase for the selected items is generated.

### CROSS REFERENCE TO RELATED APPLICATION

This application claims the benefit of US. Provisional Patent Application No. 60/906,176, filed Mar. 9, 2007 and entitled “METHOD AND SYSTEM FOR CREATING AN AFFILIATE ITEM SHOWCASE”, the contents of which are incorporated herein by reference.

### FIELD OF THE INVENTION

The invention relates to a method and system for creating item showcases for affiliate websites. More particularly, the invention relates to a method and system for automatically building and customizing item showcases and custom XML data feeds.

### BACKGROUND

The evolution of the Internet has led to the development of many new technologies and business models. These new technologies and business models can connect people and businesses at a larger scale than was previously possible and have resulted in new revenue making opportunities. One such new business model is affiliate marketing. Affiliate marketing is a method of promoting a merchant's web business(es) through third-party “affiliate” websites. An affiliate provides web links to a merchant's items in exchange for a commission or a flat fee. The merchant's items may be products, services, applications, devices, and the like. The commission is usually dependant on a customer buying an item or utilizing a service. The fee paid to the affiliate may be based on the number of visits, registrants, sales, or any combination thereof.

Often merchants join affiliate networks to set up and manage their affiliate program(s). An affiliate network is a trusted third party that provides tracking for affiliate transactions. Affiliate networks also provide a variety of tools and services to both merchants and affiliates such as analytics tools, technical support services, and commission distribution tools and services.

To track sales, leads, clicks and other statistics, merchants and networks typically depend on a cookie-based affiliate ID. This cookie-based affiliate ID is embedded in the merchant links affiliates put on their websites. Each affiliate network or independent affiliate program has a unique ID, URL, and a specific link structure. The ID, URL and link structure help track transactions that are initiated through an affiliate website to ensure that an affiliate is compensated accurately for the sales generated by the affiliate.

Both merchants and affiliate networks are beginning to offer item data feeds to affiliates. The term “data feeds” refers to data about a seller's items supplied by the seller for use by affiliates. The data may be in the form of files, data streams, web pages, or any other form of data. These data feeds may, for example, comprise product catalogs in the form of XML files, CSV files, or SOAP/REST based web services that contain information such as product description, price, availability, brand and URLs to product thumbnails.

Currently, there are several ways affiliates can add links to merchants' services and products to their websites. An affiliate can use appropriate HTML or JavaScript code that contains the necessary merchant link and affiliate ID information. Tools for doing so are commonly offered by affiliate networks and independent merchants. Some merchants and networks offer more sophisticated showcase generators that allow an affiliate to build an item showcase from periodic data feeds supplied by a merchant that contain updated product and pricing information. These showcase generators display multiple items from the same merchant and automatically embed an affiliate's affiliate ID into the generated links. For example, using the ShareASale™ Make A Page showcase generator, an affiliate may simply choose a merchant, network category, network sub-category and keyword she/he wishes to include in the affiliate site, and a large part of the task is automated. The affiliate can specify attributes for the item showcase. These attributes include, for example, border color, font, results per page, and display format (thumbnails, prices etc) and custom HTML is generated automatically based on such attributes.

There are, however, several limitations to current showcase tools. One limitation is that the existing automated showcase tools permit an affiliate to display items from only one individual merchant. Another limitation is that existing showcase tools do not allow affiliates to pick and choose individual items from within a merchant's data feed or to hide items that are not relevant to a particular affiliate. Affiliates end up with web pages created by the merchant data feeds with little room for customization and limited presentation options. The Make A Page tool for example, will only allow an affiliate to create a showcase for a merchant with whom the affiliate is already affiliated, and can only be used for a limited number of merchants. Furthermore, unless the affiliate manually edits the HTML, the data is an exact replica of the merchant's own item pages which may result in poor search engine visibility.

If an affiliate wishes to display items from multiple merchants in a customized layout, the affiliate must build those item display web pages either manually or by creating custom code that interacts with multiple merchant data feeds.

To manually create a custom layout, an affiliate must decide which products might be relevant for its customers, obtain the merchant link information for each item from the merchant or affiliate program's website, and cut and paste the proper code into the affiliate's web pages. Because there is no affiliate tool yet that allows for easy browsing across different affiliate networks (or in most cases even within networks), affiliates must often inspect many merchant sites directly to have a good understanding of the products they offer and to determine whether those products are worth adding to the affiliate's website. Even when an affiliate knows exactly which products the affiliate wants to add to its showcase, doing so involves a time consuming process including logging into each applicable affiliate network and/or independent merchant website, navigating the merchant sites, finding the desired products, copying the link that contains the tracking code for each product, and pasting that link and affiliate ID information into the affiliate's web pages.

Furthermore, item displays manually created by affiliates are typically not dynamic, i.e., they do not reflect updated product and pricing information from the merchants and are thus confined to featuring items from a merchant that exist at the time an affiliate's showcase is manually created. If a price changes, or a product becomes unavailable, then the affiliate has stale data in his or her showcase. To update this static HTML the entire showcase must be regenerated and reedited.

To create a dynamic, custom showcase for products from multiple merchants, an affiliate must be technically savvy enough to create custom code that pulls in item data feeds of different merchants, oftentimes provided in unique formats requiring custom parsing. Item data feeds generally follow no industry standards. Merchant data feeds are offered in different formats (E.g.: REST, SOAP, XML, CSV) and extensive server requirements can be required to handle the downloading and processing of multiple merchant item data files, some of which are over 1 gigabyte in size. The merchant data files are accessed in multiple methods (download, file transfer protocol (FTP), API integration). Because smaller merchants often don't have the in-house expertise to provide a properly formatted data feed an affiliate has to clean up the merchant's data when necessary. The data feeds are constantly changing, requiring a system for monitoring and updating when new files are posted. Because each data feed is different, an affiliate may have to write custom database code to standardize the various formats into a usable format for the affiliate's website. Affiliate IDs also have to be managed because some data feeds are generated with the affiliate ID embedded in the links, while others embed a generic tag such as ‘AFFILIATE_ID’ which then has to be replaced with the appropriate information.

There exists a need for a system and method that enables affiliates to select specific items and services that are of interest to them from multiple merchants across different affiliate networks, customize the way in which item showcases are presented on an affiliate's website, and that allows an affiliate's customized website to be updated dynamically without need for additional intervention by the affiliate. There also exists a need for a system and method for creating clean, custom, cross-merchant data feeds so that affiliates do not need to spend time cleaning up data feeds that follow no standards.

### SUMMARY OF THE INVENTION

A method and a system for building a customizable affiliate website showcase are disclosed. In one or more embodiments, the system and method for building the showcase comprises receiving item data feeds from multiple sellers belonging to multiple affiliate networks, parsing the data feeds and generating a comprehensive list of items from the data feeds. The list is categorized into several schemes of categorization. An affiliate selects desired items from the comprehensive list, and webpage code for a customizable item showcase for the selected items is generated.

### BRIEF DESCRIPTION OF THE DRAWINGS

FIG. 1 is a schematic representing an environment of an embodiment of the invention.

FIG. 2 is a flowchart representing a method to provide an item showcase, in accordance with an embodiment of the invention.

FIG. 3 is a flowchart representing a method to aggregate the item data feeds, in accordance with an embodiment of the invention.

FIG. 4 is a schematic representing a system for providing an item showcase, in accordance with an embodiment of the invention.

FIG. 5 is a schematic representing an exemplary item showcase in accordance with an embodiment of the invention.

### DETAILED DESCRIPTION

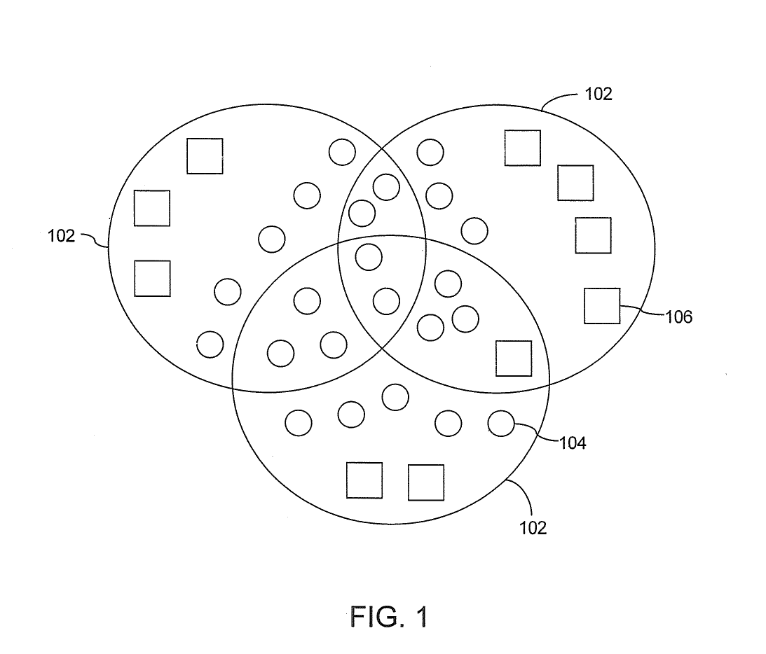

FIG. 1 is a schematic representing an environment of one or more embodiments of the invention. The environment of FIG. 1 comprises several affiliate networks 102. Each affiliate network 102 comprises affiliates 104 and one or more sellers 106. Sellers 106 have one or more items to be offered for sale online. Sellers 106 may be merchants, online stores or item manufacturers. Hereinafter, in the description of the invention, the terms “merchant” and “seller” will be used interchangeably. The items can be products, services, applications, devices, and the like. Some examples of items that are offered for sale online include books, electronic devices, airline tickets, clothing and accessories, household items and the like. Affiliates 104, through their affiliate websites, display and advertise items offered for sale by different sellers 106. Whenever a particular affiliate 104 facilitates the sale of an item of a particular seller 106 through its website, affiliate 104 gets rewarded by seller 106.

Affiliate network 102 provides an interface for interaction between affiliate 104 and seller 106. Affiliate 104 and Seller 106 may be a part of one or more affiliate networks 102. Affiliate network 102 may also provide services for creating online item showcases for the items provided by seller 106 to affiliate 104. In one or more embodiments, an item “showcase” is a web-based display of one or more items that can be viewed and accessed by a web browser, desktop application and the like. It will be apparent to one skilled in the art that there can be many other forms of displaying the items other than in a showcase without deviating from the scope of the invention.

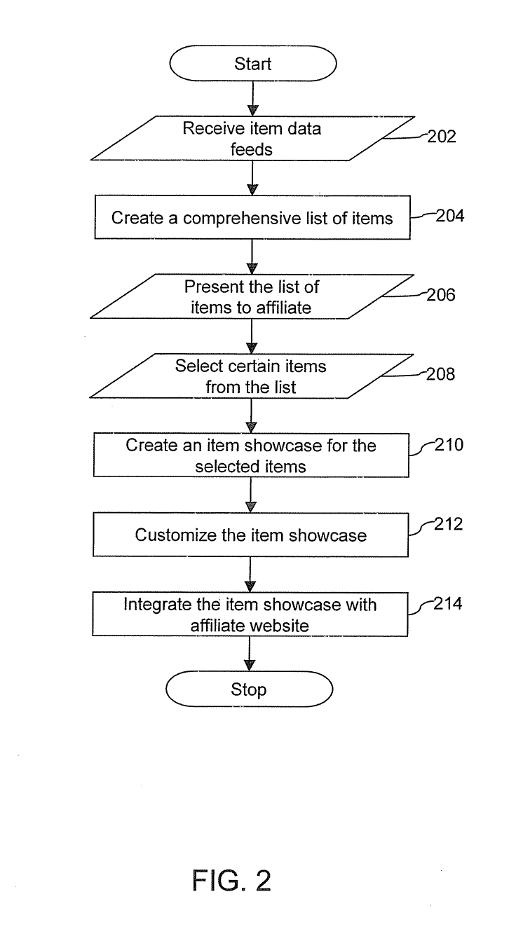

FIG. 2 is a flowchart representing a method to provide an item showcase, in accordance with an embodiment of the present invention. At step 202, item data feeds are received from a plurality of sellers 106 from across several affiliate networks 102. Item data feeds may be item catalogs in the form of XML files, CSV files, or SOAP/REST based web services. It will be apparent to a person skilled in the art that there may be several other forms of item data feeds. Item data feeds provided by sellers 106 and affiliate networks 102 may not adhere to any standard format for describing information about items or sellers. The item data feeds may be acquired through numerous means that may differ from one affiliate network 102 to another.

In an example embodiment, an affiliate network 102 is an affiliate network known as the “ShareASale™” affiliate network. The following description describes the format in which information is stored in ShareASale™ affiliate network 102 servers and also describes a process for acquiring information from ShareASale™ affiliate network 102 servers.

In the ShareASale™ affiliate network 102, an affiliate 104 must first be approved as an affiliate for a seller 106. Once approved as an affiliate, the affiliate 104 must be approved for FTP access for each seller 106, and then affiliate 104 can access the ShareASale™ FTP server. The data feed for the approved seller 106 can then be manually downloaded directly from ShareASale.com™ (linked to ShareASale™affiliate network 102) or through the provided FTP folder on the ShareASale™ server (linked to ShareASale™ affiliate network 102). Other sellers 106 in the ShareASale™ affiliate network 102 may provide their data feed as an HTTP download from a specific URL.

It will be understood that different affiliate networks may provide their data feeds in different ways and in different forms. For example, the ShareASale™ FTP server is structured differently from the FTP servers of other affiliate networks 102, such as the CommissionJunction™ FTP server and the LinkShare™ FTP server. For instance, the ShareASale™ FTP server provides a folder for each approved seller 104 within ShareASale™ affiliate network 102. The folder name may be the Merchant ID for seller 106. Inside each folder are three alternate file formats of the data feed; a .txt, .gz, and a .zip file. So an exemplary file location for a ShareASale™ data feed may be /4151/4151.txt.gz.

In contrast, the Commission Junction™ affiliate network merges all the data feeds into a single file. The single file may be stored, for example, at the following location: /outgoing/itemcatalog/10309/1612867_{—}10309_{—}20061110.txt.gz. The file can become quite large due to the inclusion of data feeds of all approved sellers 106.

In accordance with an embodiment of the invention, a script (i.e. set of computer instructions) is generated to automate the process of receiving data feeds from affiliate network 102 FTP servers. The script is run on an affiliate's computer system and/or on the affiliate network server, and may, for example, be in the form of script embedded in a webpage. The script causes the computer system on which it is run to log onto an affiliate network's FTP server using a username, a password, and FTP server information provided by affiliate network 102 at the time of registration of the affiliate with affiliate network 102. Once logged onto the server, the script determines the number of folders present at the server, and the names of the folders. The script then iterates through the folders retrieving the data feeds in the folders in the desired file format. Data feeds are periodically updated by the providing seller 106 to reflect current prices. Before downloading a file, the script determines if the data feed has changed since it was last downloaded. If the data feed has not changed, then the file is ignored and the script moves on.

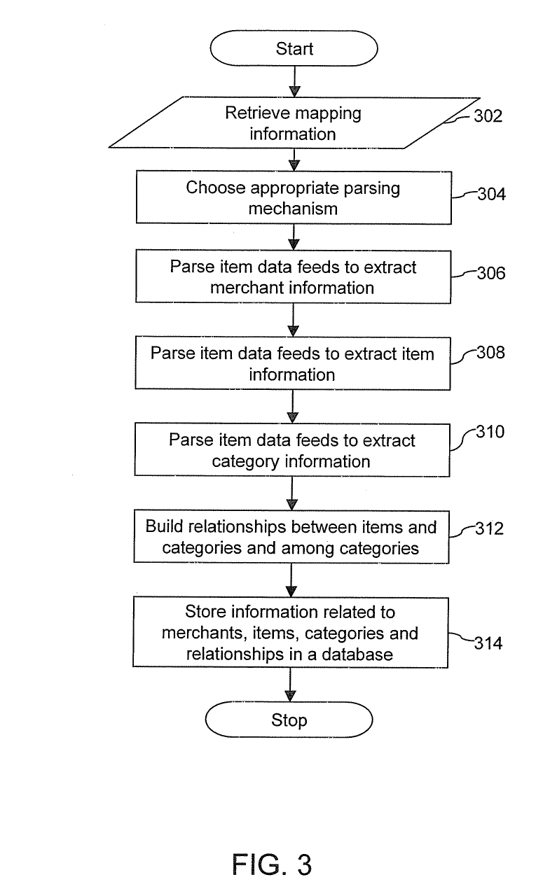

At step 204, the received item data feeds are aggregated and a comprehensive list of all items for which item data feeds have been received is generated. The aggregated list comprises all items provided by all sellers 106. If an item is provided by more that one seller 106 then every occurrence of the item is listed. Further details regarding the process of aggregation are discussed in conjunction with FIG. 3.

The comprehensive list is presented to affiliate 104 at step 206. The list may be presented in a categorized manner. The categorization may be by merchants, affiliates, item type, brand, stock keeping unit (SKU), or any other criterion. Further, affiliate 104 may be presented with a search option for searching items. The affiliate may also be presented with an option to filter out items from the list.

The categorization of items can be performed in several ways. According to an embodiment of the invention, there are three types of categories; merchant category, generalized categories and custom categories. In case of merchant categories, the items are categorized based on the merchants that provide the items. Merchant categories are categories provided by merchants and are extracted from the item data feeds received from individual merchants. Merchant categories may be further divided into sub-categories, depending on how a merchant categorizes its items.

Merchant categories provided by merchants typically follow no standards and custom coding must typically be created to extract a merchant's categories from the merchant's data feeds (in some cases the data extraction must be done manually). For instance, one merchant might designate categories in the order from general to specific using a hyphenated format (e.g.: “clothing-mens-shirts-blue”) and another merchant might a use space delimited format (e.g.: “clothing mens shirts blue”), or use a reverse format (e.g. blue-shirts-mens-clothing).

Generalized categories include items identified from across multiple item data feeds. For example, a particular seller 106 dealing with shoes may have a merchant category called “Shoes-girls” and another seller 106 may have a merchant category called “Girls shirts.” In one or more embodiments of the invention, keywords in the merchant category names are analyzed and used to generate new categories from merchant categories that have common keywords. So in the previous example the keyword “girl” is identified as being common to both merchant categories and a new top level category, “Girls”, is created with “Shirts” and “Shoes” generated as sub-categories. The items present in the top level category “Girls” will be identified from item data feeds received from both sellers 106. In one or more embodiments, the relevance and importance of keywords in relation to each other may also be determined. For example the terms “Jackets” and “Clothing” might be found together in a number of categories, while “Clothing” is found in a greater number of categories overall. In that case, it would be determined that “Clothing” should have a higher category than “Jackets,” so a “Jackets” category would be created as a sub-category of “Clothing.”

Custom categories and tags are created by affiliate 104 and are displayed only to affiliate 104, who created the categories. Custom categories can be created and modified by adding or removing one or more items, one or more merchant categories, one or more generalized categories, one or more other custom categories, or a list of brands from the category list generated by the script from the various data feeds. It will be apparent to a person skilled in the art that mere examples of categories have been mentioned in the above description and the invention supports several kinds of categories.

Subsequently, at step 208, affiliate 104 selects one or more items, item categories or a combination thereof from the comprehensive list of items presented to affiliate 104. According to an embodiment of the invention, affiliate 104 may simply point and click on specific items or item categories to add them to his or her selection. Affiliate 104 may also be presented with an option to automatically generate multiple pages of items. When affiliate 104 clicks on an “auto-feed” link, affiliate 106 is presented with a display that allows the affiliate to choose individual items, merchant categories, generalized categories, custom categories and other lists of items across all affiliate networks 102 and sellers 106. Affiliate 104 can narrow the results as needed with a keyword search or results limitation filters.

Thereafter at step 210, the item data feeds for the selected items or categories are retrieved and a showcase for the selected items is generated. In one or more embodiments of the invention, the showcase is in the form of a layout on a webpage, containing item information including the item photograph, merchant, pricing, shipping, name, description, etc.

At step 212 the showcase is customized by affiliate 104. Customization of a showcase may include modifying the layout for presentation of the items, rearranging the items, modifying or adding description of an item displayed in the showcase. Customization may also include specifying the appearance, behavior, and the text of the navigation and pagination scheme of the affiliate website. For example, affiliate 104 may change font attributes, the size of a displayed image, link behavior (open in a new window or not), link destination, the number of rows and columns in the layout grid, inclusion or exclusion of certain information (such as the merchant, shipping information, the price, etc.), layout attributes such as spacing, padding, borders, colors, paragraph alignment, image placement, overall height and width, description maximum character count limit, etc. Affiliate 104 may also modify the text in the descriptions for optimizing the search results on a search engine by using a search engine optimization (SEO) tool. SEO tools may allow affiliate 104 to “tag wrap” words of the description (e.g.: Adding <strong></strong> to every instance of a particular word), search and replace words, append or modify words, modify specified “alt” tags, etc. Affiliate 104 may choose to directly modify CSS (“cascading style sheet”) files used to describe the visual presentation of HTML tags comprising the items showcase that may be provided together generated showcase's web pages. A user interface may be provided to affiliate 104 to allow the affiliate to review and alter the CSS files as desired.

Other methods for customizing the item showcase may be provided. For example, an XML file that describes the items and categories may be generated. The XML file may then be manually customized by affiliate 104 to generate one or more affiliate websites. This enables affiliate 104 to generate the affiliate's own custom, multi-network, multi-merchant item data feed.

The methods of customization as mentioned in the above description are exemplary and it will be apparent to a person skilled in the art that customization of a showcase may include several other methods and types of modifications, addition or deletions.

After an item showcase is customized, the customized showcase is integrated with the affiliate's website at step 214. In one or more embodiments, the integration of the item showcase is achieved by generating lines of code, such as, for example, HTML code, which are provided to affiliate 104. Affiliate 104 copies the lines of code and includes the lines of code into the affiliate website. The lines of code may be in any language or script that supports the inclusion of files located on remote servers. For example, the lines of code may be JavaScript, PHP, ASP or Perl. An example of JavaScript code that may be included is, for example: <script type=“text/javascript” src=“http://www.popshops.com/shops/1191”></script>.

In one or more embodiments, Affiliate 104 may in addition or in the alternative choose to use an RSS or XML feed. Other means can be used to integrate the item showcase with the affiliate's website without deviating from the scope of the patent. For example, a static data feed can be downloaded and stored by affiliate 104 in a file or an executable file can be provided that runs at the affiliate site.

FIG. 3 is a flowchart representing a method to aggregate item data feeds, in accordance with an embodiment of the invention, to create and/or update a database of merchant and item information. At step 302, mapping information is retrieved for the current affiliate network 102. The mapping information contains a definition of the data-feed being imported. For example, mapping information may identify the delimiter (e.g. hyphen, comma, space) used to separate column fields. The mapping information may also contain a list of the file columns present in the data-feed, and information for mapping those columns to corresponding internal columns in a database. Thereafter at step 304, a parsing mechanism is chosen based on a data file type as specified in the mapping information. For example, if the mapping information is for a .csv file then a csv parsing script is selected. If the mapping information is for an XML file, a custom xml parser may be selected.

At step 306, merchant information is extracted from the item data feeds. The merchant information may include identification information for the merchant. The method to extract merchant information from the item data feeds depends on the location of the merchant information within the item data feeds. For example, in case of item data feeds that provide merchant information in rows of the file, the first row containing data is parsed, and the merchant specific information is extracted. In item data feeds that do not include merchant information, the data feed file name may be used to identify the merchant.

Subsequently at step 308, each line of the item data feed is parsed, and item information is extracted. Using the mapping information, the item information is used to create new records for the item in a database.

Thereafter at step 310, category information is extracted from the item data feeds. In one or more embodiments, category information is contained in the rows of the item data feeds and is parsed using the category delimiters identified in the mapping information. Category delimiters are the characters that separate category fields in the item data feeds. For example, seller 106 may have its category fields separated by commas, while in the next row of the data feed file a different seller 106 may have its category fields separated by a blank space. Other sellers 106 may use a hyphen, ‘-’, as a delimiter. For example, a category field may contain “Men's Shirts—Long-Sleeves”. If the mapping information does not include information identifying the delimiter used, the parser attempts to parse the categories using one or more default delimiters, for example a hyphen, comma, or space. Additional manual processes that allow management of the generated categories may be used to clean up improperly imported categories.

At step 312, relationships between items and categories and among categories are established. In order to establish relationships, category fields are split into different categories based on the results of the parsing process applied to a category field. For example, in one or more embodiments, a category field identified in a data feed as “Mens Shirts—Long-Sleeves” may result in the creation of two categories: “Mens Shirts” and “Long-Sleeves”. Once the category field is split the categories that have been created are stored in the item database being created, including parent/child relationships between the categories. Multiple fields can be provided in the item data feed rows. For example, a data feed file item row may contain a delimited list of categories in one column (‘Clothes, Winter’), while also containing a delimited list of subcategories of that category in another column (“Mens, Shirts, Long-sleeves”). In this example, in one or more embodiments, five categories are created with the following hierarchy: Clothes->Winter->Mens->Shirts->Long-sleeves. Once the categories have been created, their relationship to the item and merchant is identified.

At step 314, information related to merchants, items, categories and relationships is added to or updated in the database. In case of merchant information, a determination is made whether or not a merchant whose information is being added to the database already exists in the database. If the merchant does exist, the existing merchant information is retrieved; otherwise the extracted merchant information is used to create a new merchant entry within the database. In case of items and category information, if an item or a category is found in the existing database entries, any new information for the item or the category, such as a new price, new items etc. is updated in the database.

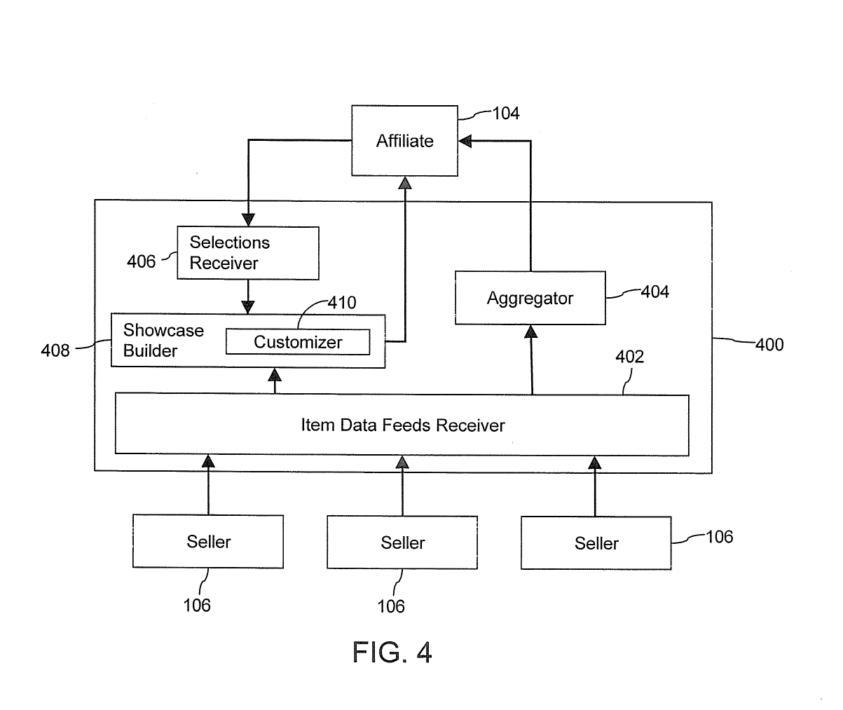

FIG. 4 is a schematic representing a system for providing an item showcase, in accordance with an embodiment of the invention. System 400 comprises an item data feeds receiver 402, an aggregator 404, a selection receiver 406, and a showcase builder 408. System 400 is connected to affiliates 104 and sellers 106.

Item data feeds receiver 402 interfaces with sellers 106 and receives item data feeds. Item data feeds receiver 402 is also connected to aggregator 404. Aggregator 404 receives item data feeds from item data feeds receiver 402. Aggregator 404 aggregates the item data feeds and creates an aggregated list of items. The aggregated list comprises all items provided by all sellers 106. In one or more embodiments, an item provided by more than one seller 106 may be listed more then once in the aggregate list. Further, aggregator 404 displays the aggregated list of items to affiliate 104. The aggregator 404 can display the list of items in one or more browser pages displayed at the affiliate's 104 computer using browser software, for example. Affiliate 104 may select certain items from the displayed list of items. Selections receiver 406 receives the selection of items from affiliate 104. Selections receiver 406 may receive selections as tags marked against certain items or item categories in a list of items. Further, in one or more embodiments, selection receiver 406 may receive showcase customization information from affiliate 104. By way of a non-limiting example, the customization information can be such as that described with reference to step 212 above. Such customization information can be input by the affiliate 104 using a user interface displayed in a browser window of browser executing at the affiliate's 104 computer, for example.

Showcase builder 408 receives a selection of items from selections receiver 406. Also, showcase builder 408 fetches appropriate item data feeds for the selected items from item data feeds receiver 402. Showcase builder 408 comprises a customizer 410. Customizer 410 customizes the showcase built by showcase builder 408. By way of a non-limiting example, the customizer 410 customizes the showcase based on input received from affiliate 104. Showcase builder 408 generates lines of code for the customized showcase and sends it to affiliate 104. The code sent to the affiliate 104 can be integrated into the affiliate's 104 web site definition. The customized showcase is then delivered to a browser user when the browser user navigates to the affiliate's 104 web site.

The customized showcase can be displayed at the user's computer using browser software executing on the user's computer. The customized showcase that is displayed at the user's computer includes products selected for the showcase and item data feeds provided from the sellers 106 for the products. As discussed herein, information contained in the item data feeds received from the sellers 106 is stored in the merchant and item information database. To build the customized showcase for display at the user's computer, the product data that is used to populate the customized showcase can be retrieved from the database of merchant and item information.

As changes are received from one or more of the sellers 106 and the database is updated to reflect the changes, the customized showcase can be updated to reflect the changes. By way of a non-limiting example, one or more browser pages can be generated to display the customized showcase at the user's computer. Data is retrieved from the database to generate a browser page definition that is used by the user's browser to display a browser page at the user's computer. The browser page definition can be cached, or otherwise stored, so that it is available to be used when referenced again by the same or another user. If there are no changes to the data used to populate the customized showcase and/or no changes to the customized showcase definition, the cached version can be served to the user computer. If there are changes to the data used to populate the customized showcase, the updated data can be retrieved from the database and used to modify the browser page definition, so that the updates can be reflected in the browser page displayed at the user computer. The browser page definition can also be updated to reflect any changes to the customized showcase definition.

In accordance with one or more embodiments, an index is maintained to identify which products are included in a given showcase. The index can be used to identify whether or not a showcase is to be updated as a result of a change in a item data feed received from a seller 106 for a given product included in the showcase.

In accordance with one or more embodiments, the initial code that is sent to the affiliate 104 comprises code that calls server-side code to generate the browser page definition(s), which are to be used by the browser to display the affiliate's 104 customized showcase. When the reference is received at a server, the server generates a browser page definition based on the customized showcase defined by the affiliate 104 and the seller's(s') item data feeds for the products included in the customized showcase. The browser page definition is served to the browser executing on the user computer to display the customized showcase at the user computer.

The system, as described in the current invention or any of its components, may be embodied in the form of a processing machine. Typical examples of a processing machine include a computer, a programmed microprocessor, an integrated circuit, and other devices or arrangements of devices that are capable of implementing the steps of the method of the current invention.

The processing machine executes a set of instructions that are stored in one or more storage elements, in order to process input data. The storage elements may also hold data or other information as desired. The storage element may be in the form of an information destination or a physical memory element present in the processing machine.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

A person skilled in the art can appreciate that the various processing machines and/or storage elements may not be physically located in the same geographical location. The processing machines and/or storage elements may be located in geographically distinct locations and connected to each other to enable communication. Various communication technologies may be used to enable communication between the processing machines and/or storage elements. Such technologies include session of the processing machines and/or storage elements, in the form of a network. The network can be an intranet, an extranet, the Internet or any client server models that enable communication. Such communication technologies may use various protocols such as TCP/IP, UDP, ATM or OSI.

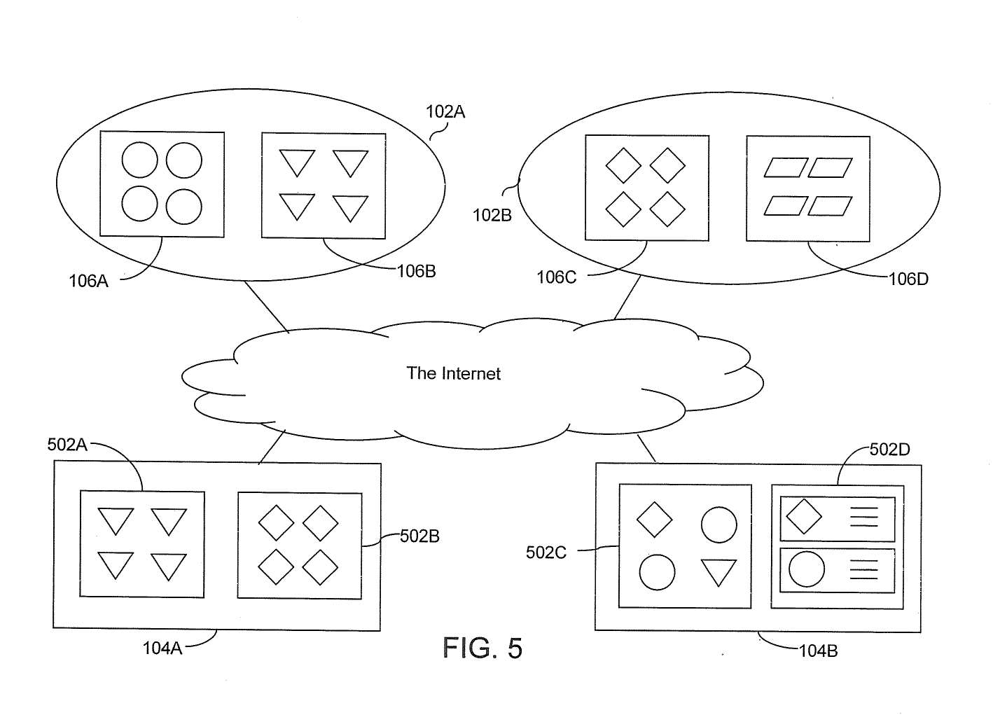

FIG. 5 is a schematic representing exemplary item showcase created by one or more embodiments of the method and system of the present invention. Affiliate networks 102A and 102B represent exemplary affiliate networks. Affiliate network 102A comprises sellers 106A and 106B and affiliate network 102B comprises sellers 106C and 106D. In FIG. 5, items provided by seller 106A are represented using circles, items provided by seller 106B are represented using triangles, items provided by seller 106C are represented using rhombuses, and items provided by seller 106D are represented using parallelograms.

Affiliate networks 102A and 102B are connected to exemplary affiliate websites 104A and 104B through the Internet. Affiliate website 104A represents an affiliate website built using the existing affiliate website building tools. Affiliate website 104B represents an affiliate website built using the method and system disclosed by the present invention.

Affiliate website 104A comprises showcases 502A and 502B. Affiliate website 104A is built using the existing affiliate website building tools, and therefore showcase 502A displays all items provided by seller 106B and showcase 502B displays all items provided by seller 106C. Affiliate 104 does not have the ability to choose individual items provided by seller 106. Neither does the affiliate have the ability to hide any item provided by seller 106.

Affiliate website 104B comprises showcases 502C and 502D. Affiliate website 104B is built using the method and system disclosed by the present invention. Showcase 502C displays selected items provided by sellers 106A, 106B and 106C. The affiliate has the ability to pick items of choice from the range of items provided by seller 106. Further the affiliate has the ability to display items from different sellers 106 in a single showcase layout. Showcase 502D displays items provided by sellers 106A and 106C. Further, showcase 502D displays additional item description for the displayed items. The affiliate has the ability to customize the showcase layout and add item description to the displayed items.

The disclosed method and system overcomes the limitations of the existing methods and systems and provides mechanisms for automatically building desired showcases to display affiliate items. The mechanisms include providing the affiliates with the ability to pick items of choice from the range of items provided by a seller. Another advantage of the disclosed method and system is providing the affiliate with the ability to choose items from different sellers from across different affiliate networks. Furthermore, the disclosed method and system provides the affiliate with the ability to customize the layout of the item showcase and to add or modify the description of individual displayed items.

While example embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A method for creating an item showcase, the method comprising the steps of:
receiving item data feeds from at least one seller, each seller offering at least one item;
creating a list of items from the item data feeds;
receiving a selection of at least one item from the list of items; and
providing an item showcase based on the selection of items.

2. The method as recited in claim 1, wherein the item data feeds are received from a plurality of sellers.

3. The method as recited in claim 1 further comprising the step of customizing the item showcase.

4. The method as recited in claim 3, wherein the step of customizing the item showcase further comprises the step of adding an item description.

5. The method as recited in claim 3, wherein the step of customizing the item showcase further comprises the step of modifying an item description.

6. The method as recited in claim 1, wherein the step of receiving a selection further comprises the steps of receiving tag information on at least one item in at least one data feed.

7. The method as recited in claim 6 further comprising the step of generating a tag list of items for which tag information is received.

8. The method as recited in claims 1, wherein the step of providing an item showcase comprises the step of creating a display based on a tag list.

9. A system for creating an item showcase, the system comprising:
an item data feeds receiver;
an aggregator for creating a list of items from the item data feeds;
a selection receiver for receiving selection of at least one item from the list of items; and
a showcase builder for providing an item showcase based on the selection of items.

10. The system as recited in claim 9, wherein the item data feeds are received from a plurality of sellers.

11. The system as recited in claim 9, wherein the showcase builder comprises an item showcase customizer.

12. The system as recited in claim 11, wherein the showcase builder further comprises an item describer.

13. The system as recited in claim 11, wherein the showcase builder further comprises an item description modifier.

14. The system as recited in claim 9 further comprising:
means for receiving tag information on at least one item in at least one data feed;
means for generating tag list of items for which tag information is received; and
means for creating a display based on the tag list.

15. A computer program product for use with a computer, the computer program item comprising a computer usable medium having a computer readable program code embodied therein for creating an item showcase, the method comprising the steps of:
receiving item data feeds from at least one seller, each seller offering at least on item;
creating a list of items from the item data feeds;
receiving a selection of at least one item from the list of items; and
providing an item showcase based on the selection of items.

16. The computer program product as recited in claim 15, wherein the item data feeds are received from a plurality of sellers.

17. The computer program product as recited in claim 15 further comprising the step of customizing the item showcase.

18. The computer program product as recited in claim 17, wherein the step of customizing the item showcase further comprises the step of adding an item description.

19. The computer program product as recited in claim 17, wherein the step of customizing the item showcase further comprises the step of modifying an item description.

20. A method for creating an item showcase for an affiliate, the method comprising the steps of:
receiving item data feeds from at least one seller, each seller offering at least one item;
creating a list of items from the item data feeds;
receiving a selection of at least one item from the list of items;
generating a custom data feed for the affiliate based on the selection of items; and
causing the item showcase to be displayed using the custom data feed.
